(19) United States
(12) Patent Application Publication
(10) Pub. No.: US 2019/0044114 A1
(43) Pub. Date: Feb. 7, 2019

(54) BATTERY REMOVAL, INSERTION AND REPLACEMENT

(71) Applicant: Peter J. DeMar, Oswego, NY (US)

(72) Inventor: Peter J. DeMar, Oswego, NY (US)

(21) Appl. No.: 15/668,780

(22) Filed: Aug. 4, 2017

(51) Int. Cl. H01M 2/10; H01M 2/12; H01M 6/42

(52) U.S. Cl. CPC H01M 2/1077; H01M 2/1061; H01M 2220/10; H01M 6/42; H01M 2/12

(57) ABSTRACT

A battery apparatus includes a cell that is accommodated in a battery-tray/module. The cell is comparatively tightly fitted into the battery-tray/module, and a relative pressure inside and outside the cell determines a relative ease of removal and replacement of the cell with respect to the battery-tray/module. Also considered are methods for removal and replacement of a cell within the battery-tray/module in accordance with the foregoing battery apparatus.

### BACKGROUND

### Field of the Invention

Embodiments relate generally to removing, inserting and replacing two volt valve regulated lead acid (VRLA) cells within a battery-tray/module. More particularly, embodiments relate to removing, inserting and replacing two volt VRLA cells with greater facility within the battery-tray/module.

### Description

Two volt VRLA cells may be fabricated in a number of form factors that are specific to a plurality of different applications. In general however, for common applications two volt VRLA cells are routinely fabricated in a rectangular form factor and installed into a generally tightly fitted rectangular form factor support structure. Such a support structure is referred to in the industry, and also hereinafter, as a “battery-tray/module.”

These battery-tray/module assemblies have rigid vertical sidewalls and a horizontal floors that contact and constrain the sidewalls (i.e., for three or four sides) and bottom of the two volt VRLA cell which is positioned within a battery-tray/module. Typically a battery-tray/module is fabricated so that each individual two volt VRLA cell has its own five sided enclosure (i.e., three sidewalls plus top and bottom), and a when a number of these enclosures is assembled together the resulting enclosure is considered in the industry to be a multi-tray battery-tray/module. While there are some large two volt VRLA cells that utilize a single battery-tray/module per two volt cell, the majority of the battery-tray/modules is designed to accommodate a multiplicity of cells in an individual battery-tray/module. The typical battery-tray/module accommodates three to six cells. Some battery-tray/module assemblies allow for two cells to be fitted side by side within a single open space in the battery-tray/module.

The number of battery-tray/modules and the number of cells utilized will determine the total voltage and amp capacity of a respective battery string needed for a particular anticipated battery use application. The completed battery system when assembled (i.e., a battery-tray/module including a plurality of cells) is considered a battery. Some very common voltages of assembled batteries are 12, 24, 36, 48, 120, 240, and 480, although the final voltage of a resulting battery could be any value that is divisible by 2 volts.

While such battery-tray/module assemblies are desirable within the context of battery based energy storage, transport, and utilization, such a tightly constrained battery-tray/module support arrangement for a plurality of cells in a typical battery application is not entirely without difficulties. In particular, such a tightly fitted rectangular form factor battery-tray/module often provides difficulties when removing a cell from such a rectangular form factor battery-tray/module when the cell has been resident within the battery-tray/module for a protracted period of time.

Thus, desirable within any typical application of these VRLA batteries, as well as other form factor and composition batteries, are methods, materials, designs and apparatus that provide for removal, installation, and replacement of the cells within battery-tray/modules with greater facility.

### SUMMARY

The embodiments provide a cell and a battery tray/module apparatus which when paired together provide desirable facile removal and replacement properties of the cell with respect to the battery-tray/module apparatus.

The embodiments also provide a method for removing, inserting, or replacing a cell within a battery-tray/module with enhanced facility.

The method of the embodiments realizes the foregoing objects by relatively inwardly deforming at least one cell outer surface with respect to at least one battery-tray/module mating outer surface, prior to and during movement, such as but not limited to removal, insertion and/or replacement, of the cell within the battery-tray/module. This relative inward deformation reduces the adhesion between the at least one cell outer surface and the at least one battery-tray/module mating outer surface, thereby reducing an effort required to perform the cell movements relative to the battery-tray/module as described above.

In general, the embodiments provide a method for reducing an amount of physical effort required to remove, insert, or replace a cell with respect to a battery-tray/module. The embodiments also provide an apparatus comprising a cell and a battery-tray/module assembled to have technical features consistent with the method in accordance with the embodiments. Such a method in accordance with the embodiments is particularly useful within (but not limited to) the context of two-volt valve regulated lead acid (VRLA) cells being removed from, inserted into, or replaced within a battery-tray/module, particularly within the context of a field service operation of the VRLA cells or other types of cells. Thus, the apparatus and method in accordance with the embodiments is applicable beyond VRLA cells and beyond field service operation of VRLA cells.

As is understood by a person skilled in the art, two-volt VRLA cells are commonly assembled into battery-tray/modules in a high density configuration and further typically also in a close quartered environment.

The embodiments provide that in order to facilitate removal, insertion, or replacement of a cell with respect to a battery-tray/module within the context of a field service operation in accordance with the embodiments, at least one cell outer surface is relatively inwardly deformed (relative to the normal operational shape of the at least one cell outer surface) to provide at least one relatively inwardly deformed cell outer surface. The at least one relatively inwardly deformed cell outer surface provides reduced adhesion, friction and suction when removing, inserting or replacing the cell with respect to the battery-tray/module.

While other methods for relatively inwardly deforming at least one cell outer surface with respect to a battery-tray/module mating outer surface are not precluded within the context of the embodiments, a particularly efficient approach provides that a vacuum be drawn on the cell which often includes a cell case. This causes the cell (or the cell case) to develop at least one relatively inwardly deformed cell outer surface which facilitates removal, insertion, or replacement of the cell with respect to the battery-tray/module.

An apparatus in accordance with the embodiments includes a battery-tray/module comprising: (1) at least two vertical sidewall components horizontally separated from each other; and (2) at least one horizontal tray component that horizontally separates and connects to the at least two vertical sidewall components. The apparatus also includes at least one cell assembled into the battery-tray/module component. Within the apparatus, at least one of the cell outer surfaces is subject to a relatively inward deformation as a function of a pressure difference between the inside of the cell and the outside of the cell.

In that regard, and in normal operation of a VRLA cell, there is a greater pressure inside of the cell than outside of the cell when a pressure vent is in place and operative with respect to the cell, as is normal for the cell. Within the embodiments and description that follows, a method in accordance with the embodiments provides at least one relatively inwardly deformed cell outer surface is provided incident to a lower pressure inside the cell than outside the cell.

A method in accordance with the embodiments includes relatively inwardly deforming, with respect to a cell supported by a battery-tray/module, at least one cell outer surface at a point of contact of the at least one cell outer surface and at least one battery-tray/module mating outer surface, to form a relatively inwardly deformed cell outer surface. The method also includes moving the cell with respect to the battery-tray/module in the presence of the at least one relatively inwardly deformed cell outer surface.

Another method in accordance with the embodiments includes drawing, within an apparatus that comprises a cell and a battery-tray/module having at least one cell outer surface that contacts a battery-tray/module mating outer surface, a vacuum within the cell that provides at least one relatively inwardly deformed cell outer surface at the location of a battery-tray/module mating outer surface. This particular method also includes moving the cell with respect to the battery-tray/module in the presence of the at least one relatively inwardly deformed cell outer surface.

### BRIEF DESCRIPTION OF THE DRAWINGS

The objects, features and advantages of the embodiments are understood within the context of the Detailed Description of the Preferred Embodiments, as set forth below. The Detailed Description of the Preferred Embodiments is understood within the context of the accompanying drawings (and images), which form a material part of this disclosure, wherein:

FIG. 1 shows a schematic perspective-view diagram of a battery-tray/module apparatus in accordance with the embodiments.

FIG. 2 shows a schematic perspective view diagram of a cell in accordance with the embodiments.

FIG. 3 shows a perspective view image of a cell in accordance with the embodiments.

FIG. 4 shows a cell in a battery/tray module and further illustrating a closely constrained fit in accordance with the embodiments. Also illustrated is a cell puller spanning and attached to the two vertically aligned left hand electrode connections on the right hand cell. Further also illustrated is a vacuum connection within the center face of the right hand cell and having a length of tubing attached thereto.

FIG. 5 shows a cell outer surface aligned with an open location of a battery-tray/module. Show in particular is a pressurized shape (i.e., a relatively outwardly deformed shape) of the cell top outer surface in accordance with normal operation of the cell.

FIG. 6 shows a cell that was pressurized, and from which pressure has been released, to provide under vacuum a relatively inwardly deformed cell outer surface in accordance with the embodiments.

FIG. 7 shows a battery-tray/module with one cell removed in accordance with the embodiments.

FIG. 8 shows a typical string of battery-tray/modules intended to accommodate sixty cells in accordance with the embodiments, but occupied by no cells.

### DETAILED DESCRIPTION OF THE PREFERRED EMBODIMENTS

The embodiments describe a method for removing a cell from a battery-tray/module with enhanced facility. The embodiments also contemplate an apparatus including a cell within a battery-tray/module in accordance with the method.

General Considerations

Most generally, ease of removal of a cell from a battery-tray/module in accordance with the embodiments is facilitated by relatively inwardly deforming at least one cell outer surface at a point of contact of the at least one cell outer surface with a battery-tray/module mating outer surface, while removing, installing or replacing a cell with respect to the battery-tray/module.

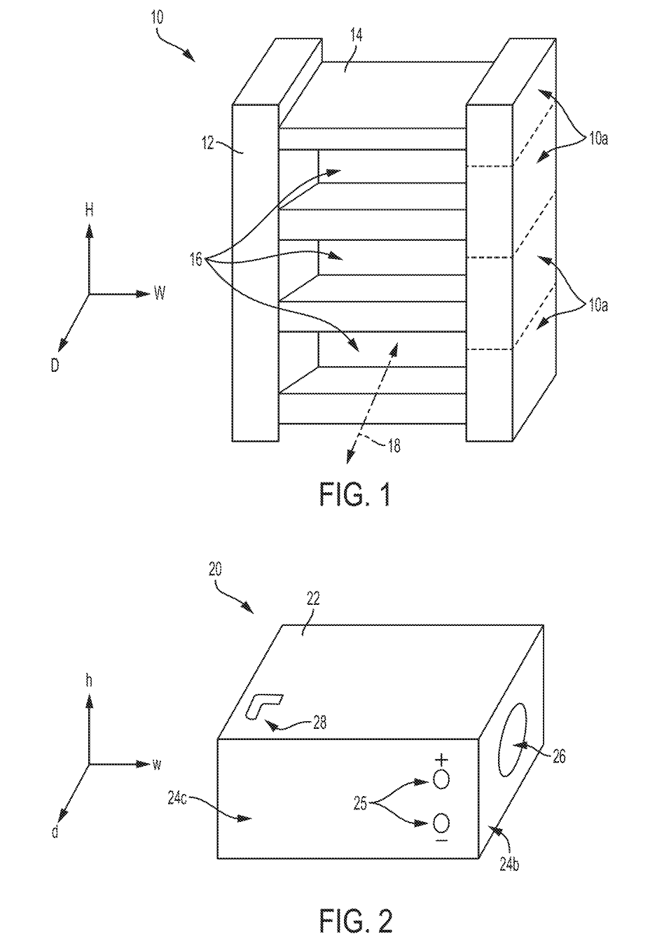

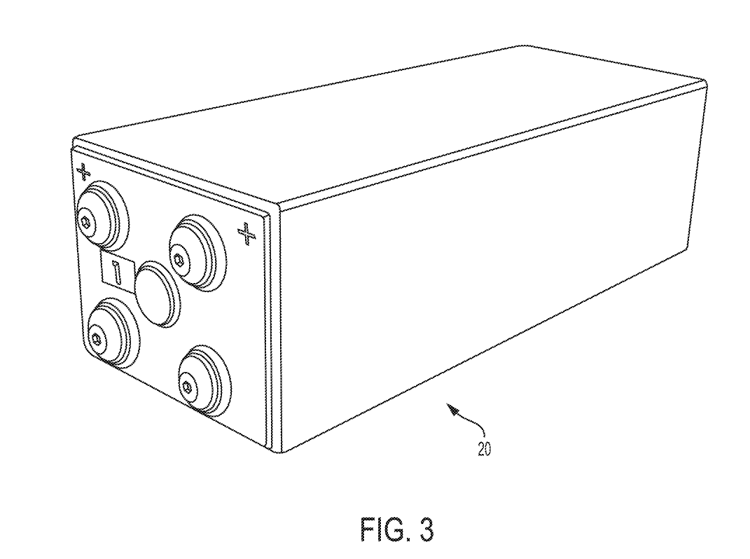

This particular aspect of the embodiments may be illustrated in a first instance within the context of the schematic diagram of FIG. 1 which illustrates a multi-tray battery-tray/module 10 in accordance with the embodiments. As is illustrated in FIG. 1, the multi-tray battery-tray/module may derive from stacking a plurality of single-tray battery-tray/modules 10a. The multi-tray battery-tray/module 10 comprises a pair of vertical sidewall sections 12 where each vertical sidewall section 12 is uniformly horizontally separated from the other vertical sidewall section 12. The multi-tray battery-tray/module 10 also includes a plurality of horizontal tray sections 14 (that define a plurality of interposed open locations 16 for a corresponding plurality of cells) that are uniformly vertically separated from each other and connected at each end to the pair of vertical sidewall sections 12. The vertical sidewall sections 12 are commonly although not necessarily solid, and may be conductive and may thus serve as a heat sink to dissipate through the battery-tray/module 10 heat from a cell that is located in an open location 16 and supported by a battery-tray/module tray section 14 within the multi-tray battery-tray/module 10. The cell may be removed, inserted and replaced into a horizontal tray section 14 within the battery-tray/module 10 in the generalized directions in accordance with the bidirectional arrow corresponding with reference numeral 18.

Dimensions of each battery-tray/module 10a within the multi-tray battery-tray/module 10 in accordance with FIG. 1 are variable to accommodate particularly sized cells, but in general each battery-tray module 10a within the multi-tray battery-tray/module 10 has: (1) a height H from about 8 to about 12 inches; (2) a width W from about 15 to about 44 inches; and (3) a depth D from about 16 to about 30 inches, where H, W and D are also defined in FIG. 1.

Other particular aspects of the embodiments are also illustrated in a second instance within the context of FIG. 2 which illustrates a cell 20 which is intended to fit into one of the open locations 16 within the multi-tray battery-tray/module 10 of FIG. 1. The cell 20 includes (and is fully enclosed by) a cell case 22 at least one of whose outer surfaces may be relatively inwardly deformed or relatively outwardly deformed as a function of a relative pressure between the inside of the cell case 22 and the outside of the cell case 22. The cell 20 also includes at least one pair of terminal posts 25 penetrating through the sidewall 24a. The cell 20 finally includes an access fixture 28 at the location of a vent assembly that has been removed. FIG. 2 shows the sidewall 24b outer surface as relatively inwardly deformed as evidenced by the arrow 26.

The dimensions h, w and d of the cell 20 correlate with the dimensions H, W and D of the multi-tray battery-tray/module 10 with the exception that a cell height h and width w is a fraction of an inch (i.e., from about 1/16^{th} to about ½ inch and preferably from about 1/16^{th} to about ¼ inch) less on each side than the battery-tray/module height H and width W.

Although not limiting with respect to the embodiments, a method in accordance with the embodiments is desirably utilized in battery field service operations where, for example and without limitation, two-volt VRLA cells are desirably removed, inserted, and replaced with respect to a battery-tray/module. The two-volt VRLA cells may be removed, inserted, and replaced with respect to applications that include but are not limited to inoperative stationary use (i.e., storage use) applications, operative stationary use applications and operative mobile use applications of the VRLA cells.

As is understood by a person skilled in the art, battery-tray/modules are commonly but not necessarily exclusively manufactured of steel, and they typically have all metal surfaces coated with a non-conductive coating which also can be anti-corrosive, such as but not limited to an epoxy type paint, although other types of coating of the metal surfaces may be utilized.

Within the context of the embodiments, a stationary use battery is defined as a battery that during normal operation remains in its installed position while it is performing its intended function.

As is also understood by a person skilled in the art, two-volt VRLA cells typically are mounted horizontally (posts facing sideways), but can also be mounted vertically (posts facing upward) if particular design considerations are appropriate for that orientation.

A minimum number of posts in each individual two-volt VRLA cell will be two posts (one positive and one negative). A two-volt VRLA cell can have multiples of those two posts, depending upon the cell design and size (amp-hour rating, capacity application requirement and physical dimension constraints). Typically a lower amp-hour rating will command a lower number of sets of posts, and the larger cells may have a greater number of sets of posts. The number of sets of posts usually will range from one set to five sets, with greater numbers of sets over five not being excluded.

VRLA cells throughout their lives are normally operating with an internal cell pressure that is greater than the atmospheric pressure that is outside of the cell. This is considered a “positive” pressure. This requires the cell vent or vents to be secure (air tight) so that no external air can enter the battery during normal operation. Generally, a vent assembly includes a one way valve that allows internally generated excess gases to be released when the internal pressure exceeds a specific desired internal pressure. Different manufacturers and designs utilize differing release pressure valves in their cell vent assemblies. After releasing the excess pressure, the vent valve reseals itself and no external air is allowed into a cell which is serviced by such a vent valve. Most two-volt VRLA cells utilize one vent valve per cell, but some designs do have more than one vent valve per cell.

Battery field service is defined as battery maintenance, testing, repair, or replacement work that is being performed anywhere outside of the confines of the physical manufacturing plant facility where the two-volt VRLA cell was originally manufactured and assembled for shipment. Within the context of the embodiments the method of the embodiments will apply whenever a two-volt VRLA cell is being removed from, inserted into, or replaced in a battery-tray/module that is not occurring at the place of the original manufacture. These locations could be wherever a battery is being utilized for a particular application, or anywhere a cell is physically being removed from, inserted into, or replaced in a battery-tray/module.

Examples of these applications could be in any of the following fields: telecom, UPS, data centers, power generation, switchgear and control, energy storage, process control, medical support, safety, manufacturing, and any other application where two-volt VRLA cells are being utilized in a battery. Moreover, a method in accordance with the embodiments would apply at any location where a cell is being removed, inserted, or replaced in preparation for other actions. Some examples where this method might be performed could be in a warehouse, service center, staging area, the room where the batteries are being worked on, or even in a vehicle (truck or trailer) wherever the actual cell removal, insertion, or replacement work is being performed.

A method in accordance with the embodiments reduces the amount of physical effort required to remove or insert a cell from or into a battery-tray/module or replace a cell in a battery-tray/module by breaking the contact or reducing the contact between at least one cell outer surface and at least one battery-tray/module mating outer surface, thereby reducing the adhesion, friction and suction between those two outer surfaces. A battery-tray/module is commonly coated with an epoxy type coating in order to reduce the risk of an electrical short-circuit from a cell (or a plurality of cells) to ground, however there may be battery-tray/module surfaces that are not coated in this manner, but rather in another manner, or not coated at all, although a method in accordance with the embodiments may still be utilized to ease removal and replacement of a cell with respect to a battery-tray/module under any of the foregoing circumstances.

There are primarily two different type of plastic materials that may be used in the manufacture of the battery cell case enclosures that are utilized in the further manufacturer of two-volt VRLA cells (such an enclosure is the electrically inoperative plastic component part (also referred to as a “jar”)) that contains the electrically operative battery components). One such plastic material is more rigid and in some designs is able to be used without having an additional rigid enclosure component around a cell to maintain the cell desired shape and compression. PVC (polyvinylchloride), SAN (styrene-acrylonitrile), and other higher temperature thermoplastics are common plastics used in these cell cases.

The other type of plastic material utilizes a softer thermoplastic polymer material having a lower glass transition temperature (Tg) and does require a rigid enclosure component to maintain its form and function. The primary plastic used in these is of the polyolefin technology class, such as but not limited to polypropylene, however an alternative technology class may be employed if a particular cell manufacturer chooses to utilize an alternative specific material.

A method in accordance with the embodiments is primarily utilized with any cell that requires a rigid enclosure component in order to maintain its shape and function. The rigid enclosure component (which may be, but is not limited to, a battery-tray/module) is typically fabricated from steel, but could be manufactured from another rigid material.

The plastic cell case (i.e., “jar”) outer surfaces and the battery-tray/module mating outer surfaces over time adhere to each other and it becomes very difficult to remove an installed cell from a battery-tray/module absent use of substantial applied force or assistive mechanical devices. Moreover, successful cell removal and replacement in absence of the instant inventive methodology and apparatus often will require numerous maintenance personnel, and mechanical devices. While other rationale and explanations are not precluded, this adhesion may be the result of the softer plastic of the cell outer surfaces including but not limited to sidewalls, over time and due to the constant positive internally generated gas pressure, filling in the voids or pores of the surface of the battery-tray/module mating outer surfaces and interlocking the cell outer surfaces together.

Within a method in accordance with the embodiments, utilizing a vacuum causes at least one of the cell outer surfaces to relatively inwardly deform, and separate away from full contact with a corresponding at least one battery-tray/module mating outer surface. This relatively inwardly deformation changes a normal cell outer surface from having a generally convex shape to a generally concave shape, or even just to a flat shape, or possibly just a less convex shape. By changing the cell outer surface shape a reduced effort is required to perform the task of removing, inserting, or replacing a cell with respect to a battery-tray/module. Once a cell is removed from the battery-tray/module in accordance with the embodiments the vacuum is removed and the cell outer surfaces over time will return to their normally somewhat convex shape. To insert the cell into the battery-tray/module the method in accordance with the embodiments is utilized to relatively inwardly deform at least one cell outer surface (in general with a more concave shape), and after the cell is moved relative to the battery-tray/module the vacuum is removed and the at least one cell outer surface returns to normal convex shape and establishes contact with the battery-tray/module mating outer surface.

The contact between the cell outer surface and the battery-tray/module mating outer surface when the cell is in normal operation is important to the proper functioning of the cell.

By removing the majority of the contact area of the cell outer surface with the battery tray/module mating outer surface the effort required to remove and replace a cell with respect to a battery-tray/module is reduced. There will always be some amount of contact between a cell outer surface and a battery-tray/module mating outer surface, but such contact is substantially reduced when removing, inserting, or replacing a cell within a battery-tray/module in accordance with a method in accordance with the embodiments.

A preferred embodiment of a method in accordance with the embodiments is implemented in accordance with a battery-tray/module as illustrated in FIG. 1 and a cell as illustrated in FIG. 2. This method is performed as follows. First, prior to executing the process steps in accordance with the embodiments, all of the routine process steps required in preparation of a cell for a cell removal, insertion, or replacement are performed. These routine process steps might include, but are not necessarily limited to, strap removal, connector removal or terminal plate removal, as well as cell retainer bar removal or cell retainer tab removal and cell vent removal. All typical procedures required up to the point where the physical effort commences to remove, insert or replace a cell within a battery tray/module will remain unchanged as those process steps previously performed in absence of the inventive methodology and apparatus.

If appropriate, removal of a cell vent or a cell vent assembly if not previously removed is to be removed from the cell, which will allow the external and internal air pressure to equalize. The cell vent may need to be removed completely from the cell in order for a method in accordance with the embodiments to function properly. In an alternative, an additional access hole could be drilled into the a cell case to allow for this equalized pressure, but such an access hole could render the cell unusable, unless there is a process performed that would enable airtight closure of the drilled opening upon completion of the cell removal, insertion, or replacement with respect to a battery-tray/module.

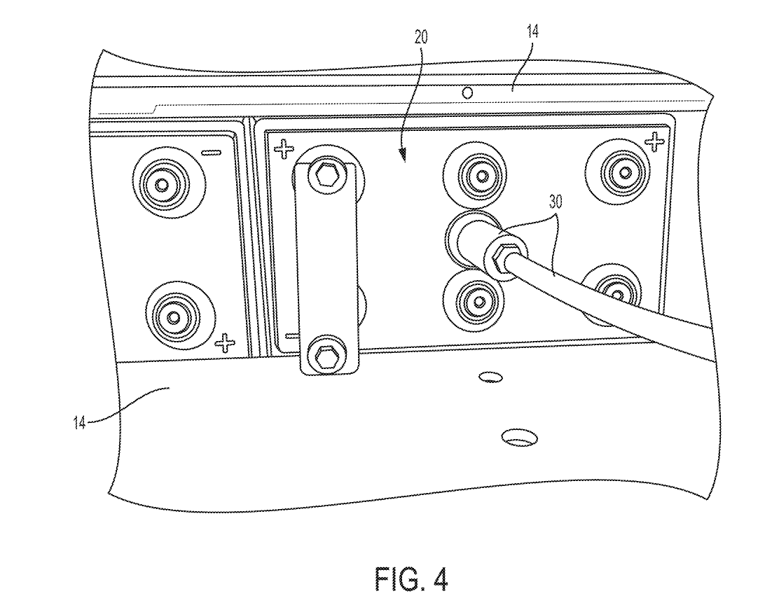

In a subsequent process step, an apparatus that will create a vacuum of sufficient magnitude to deform the cell outer surfaces as described previously, is connected to the cell in such a manner that the vent opening or alternative pressure equalizing access opening is securely connected to the vacuum creating apparatus either by a fitting (i.e., a component part that engages the cell physically) being inserted and engaged in the vent opening, or by the vent opening being covered by a length of tubing or hose. There are two primary methods for achieving this result as described below. The image of FIG. 4 shows for example a vacuum coupling and tubing 30 while a remaining portion of a vacuum apparatus is not within the image field.

In a first sub-method of this process step, a length of tubing type material (i.e., tubing or hose) can encircle a vent opening, with no part of a vent connection apparatus being required to enter the vent opening in order to function. By applying a vacuum the end of the apparatus secures itself to the cell case around the vent opening and the extraction of the internal air pulls the apparatus into secure contact with the battery case. That air extraction pulls the cell outer surfaces away from contact with the battery-tray/module mating outer surfaces, and the cell can be easily removed, inserted, or replaced with respect to the battery tray/module.

As an analogy, this particular aspect of a method in accordance with the embodiments correlates with using a round hose on a conventional vacuum cleaner as a vacuum apparatus for removal of debris or an obstacle out of an indent or hole in a floor, which does have sides and a bottom. The round tubing type material is placed in secure contact with the flat surface and the vacuum created pulls the object into the hose. This method would require the person performing the process to maintain contact (hold) the tubing or hose in place for the duration of the removal or insertion of the cell.

In a second sub-method, the tubing type material can have an end (vent connection apparatus) that is the same shape and design as the normal vent assembly and this end is inserted into a vent opening and secured in the same manner as the original vent assembly (commonly either in a screw-in manner, or a bayonet type insertion manner). Such a bayonet type insertion and turning into a fully locked position creates an air tight connection. The vacuum is applied and the cell outer surfaces again nominally inwardly deform from contact with the battery-tray/module mating outer surfaces and the cell is easily removed from the battery-tray/module.

As an analogy, this particular aspect of the second sub-method compares with a procedure of connecting a central home vacuum system to a vacuum hose that is moved from room to room and plugged into a vacuum cleaner hose fitting in the wall that creates the tight fit so that the central vacuum as a vacuum apparatus may provide the vacuum needed to pull an object from these other rooms into a central vacuum collection point. A fitting or connector on the tubing or hose that is connected to a central vacuum wall outlet must properly fit the opening or the central vacuum will not work. This method would allow the person performing the process to have their hands free for other activities, such as the actual physical activity of removing or inserting a cell relative to a battery-tray/module.

As is understood by a person skilled in the art, a vent connection apparatus can have either a fixed design end (end that is inserted into a battery cell case) for an applicable manufacturer's vent opening, or it can have removable or interchangeable ends that allow a user to change ends to fit the appropriate vent design, or to enable replacement of the inserted end if it wears out or becomes damaged.

Such a vent connection apparatus in accordance with the embodiments can be manufactured from any non-permeable material that is machineable, or manufactured as applicable for the material or application. The material can be either conductive or non-conductive. Preferably the material will be compatible with a battery electrolyte, but that is not a requirement, particularly under circumstances where the vent connection apparatus is readily replaced. A permeable material could be utilized but it would be required to have enough resistance to air passage that it would allow the required vacuum to be introduced into a cell to relatively inwardly deform at least one cell outer surface, and to hold that vacuum (and retain the relatively inwardly deformed cell outer surface), during a cell removal, insertion or replacement process.

A vent connection apparatus utilizes an air passage that is internal to the apparatus which allows air to be drawn from inside a cell by vacuum, to outside of the cell when it is properly seated into the vent opening. If the apparatus is not properly seated and cannot provide cell outer surfaces that are relatively inwardly deformed, then it will not function as designed.

A vacuum apparatus that may provide suction in accordance with the embodiments may be, but is not necessarily limited to a hand operated vacuum pump device, a foot operated vacuum pump device, a mechanical operated vacuum pump device, a hydraulic operated vacuum pump device, an electric powered (AC or DC) vacuum pump device, or any other vacuum apparatus or device that has the ability to provide a vacuum of sufficient capability to deform the at least one cell outer surface away from contact with at least one battery-tray/module mating outer surface. The specific amount of vacuum required for each cell will be dependent upon the degree of adhesion, friction and suction between the at least one cell outer surface and the at least one battery-tray/module mating outer surface. A cell that has been installed for a longer period of time often requires a greater amount of vacuum than does a cell that is new or relatively new, and whose relevant surfaces have not yet become as adhered to each other. A cell whose vent release pressure is higher than a cell with a lower vent release pressure might also require a greater vacuum. A cell that has been operated at an elevated temperature, or abused by extended over charging also typically requires a greater vacuum. A cell that has experienced thermal run-away also typically requires a great amount of vacuum.

Also, an amount of vacuum (or vacuum time) is influenced by mechanical characteristics and thicknesses of materials from which is comprised a cell or a cell case.

A vent connection apparatus can be fabricated in such a way that it has a means of attachment that will allow the user to grip with their hand or hands, or to connect an attachment for pulling a cell from a battery-tray/module. This can be as simple as an attachment handle through the apparatus, or a means to screw an eye or ring into for fastening another means of pulling a cell from a battery-tray/module, or any method that will allow for applying the necessary force to remove a cell from a battery-tray/module. This allows for ease of insertion of a cell into the battery-tray/apparatus and a twisting motion to engage the apparatus securely into the vent opening.

The vent connection apparatus can also be fabricated in such a manner that it is not to include a means of utilizing the apparatus to physically pull a cell from a battery-tray/module, but rather the apparatus is utilized primarily to make a secure fitting with the cell vent so that the vacuum can be drawn on the cell. With this design there usually will be required a separate means of providing a physical connection to the cell in order to be able to apply a force required to pull a cell from the battery-tray/module. The apparatus used to physically pull the cell is usually called a cell puller. With this method of creating the vacuum, it is easier and quicker to remove the battery with a cell puller, but either means of connecting to the cell can be used.

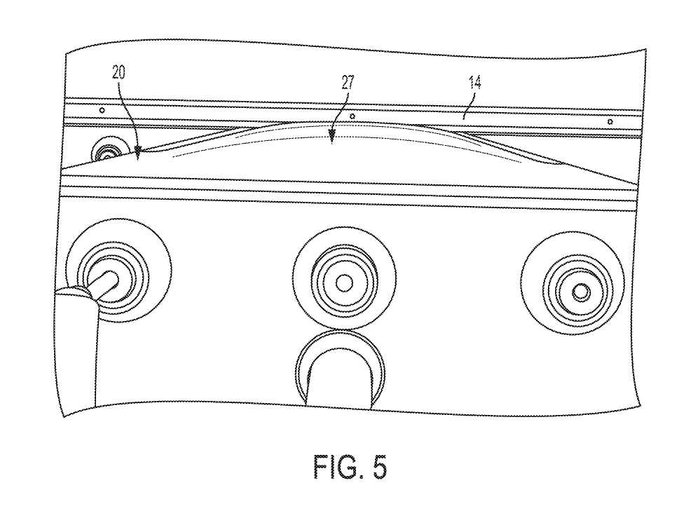

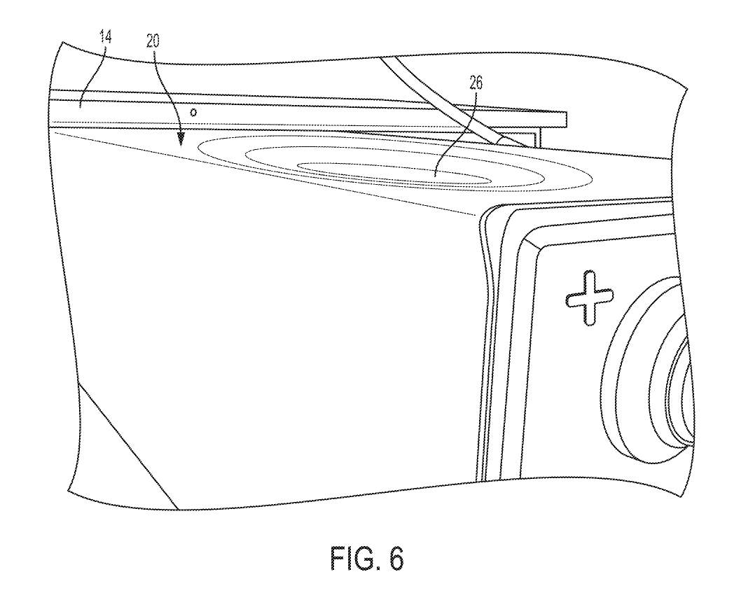

For reference, FIG. 5 shows a cell 20 under positive operational pressure that provides a convex cell outer surface 26 which impedes removal, insertion or replacement of the cell 20 with respect to a battery-tray/module. For further reference, FIG. 6 shows the same cell 20 under negative pressure vacuum which provides a concave cell outer surface 27 which in turn further facilitates removal, insertion and replacement of the cell 20 with respect to the battery-tray/module.

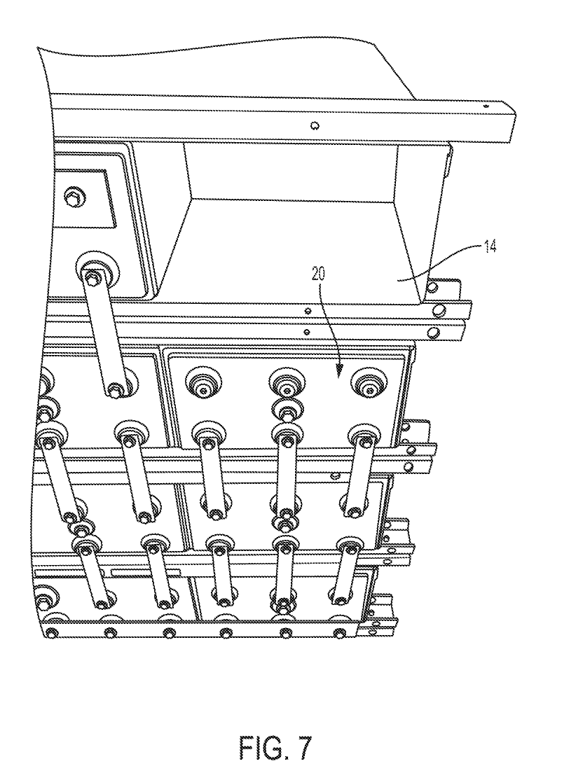

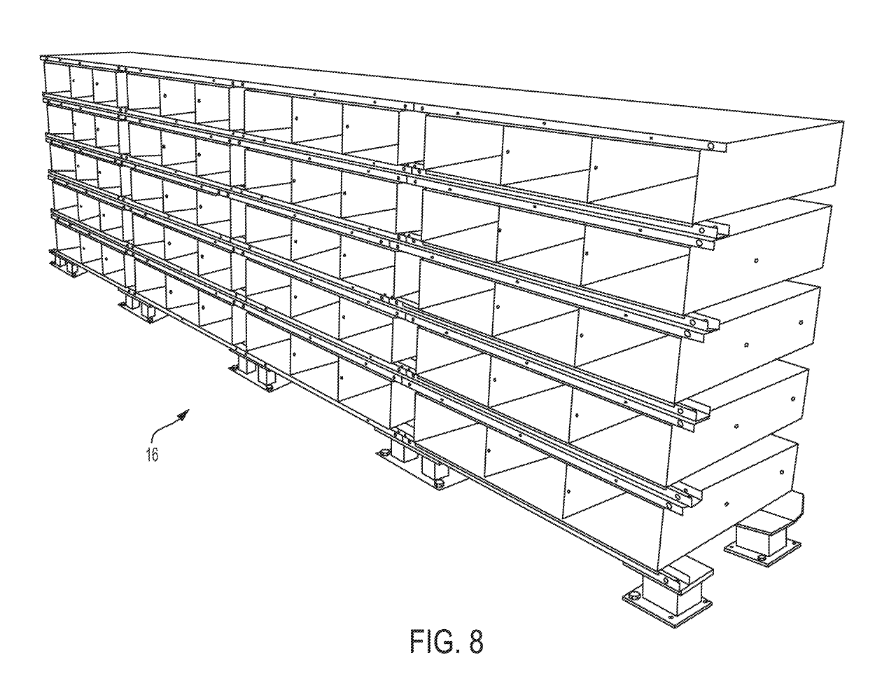

Moreover, FIG. 7 shows a battery-tray/module that is otherwise fully populated with cells but wherein one corner cell location is unoccupied. Finally, FIG. 8 shows a battery-tray/module intended to accommodate sixty cells, but otherwise unoccupied and containing no cells.

### CONCLUSION

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An apparatus comprising:
a battery-tray/module comprising:
at least two vertical sidewall components horizontally separated from each other; and
at least one horizontal tray component that separates and connects to the at least two vertical sidewall components; and
a cell assembled into a horizontal tray component, wherein at least one cell outer surface is subject to a deformation as a function of a pressure difference between the inside and the outside of the cell.

2. The apparatus of claim 1 further comprising a vent connection through a cell case from which is comprised the cell.

3. The apparatus of claim 2 further comprising a vacuum source connected to the vent connection.

4. The apparatus of claim 3 wherein the pressure difference between the inside and outside of the cell determines an ease of removal or replacement of the cell with respect to the battery-tray/module.

5. The apparatus of claim 1 wherein:
the battery-tray/module has a height dimension from about 8 to about 12 inches;
the battery-tray/module has a width dimension from about 15 to about 44 inches; and
the battery-tray/module has a depth dimension from about 16 to about 33 inches.

6. The apparatus of claim 1 wherein the battery-tray/module has at least one mating outer surface relative to the at least one cell outer surface that is subject to deformation.

7. A method for battery removal or replacement comprising:
relatively inwardly deforming, with respect to a cell supported by a battery-tray/module, at least one cell outer surface at a point of contact of the at least one cell outer surface and a battery-tray/module mating outer surface to form at least one relatively inwardly deformed cell outer surface; and
moving the cell with respect to the battery-tray/module in the presence of the at least one relatively inwardly deformed cell outer surface.

8. The method of claim 7 wherein the moving the cell comprises removing the cell.

9. The method of claim 7 wherein the moving the cell comprises replacing the cell.

10. The method of claim 8 wherein an extent of the relatively inwardly deforming of the at least one cell outer surface at the point of contact of the cell outer surface and the battery-tray/module mating outer surface determines an ease of removing the cell from the battery-tray/module.

11. The method of claim 9 wherein an extent of the relatively inwardly deforming of the at least one cell outer surface at the point of contact of the cell outer surface and the battery-tray/module mating outer surface determines an ease of replacing the cell within the battery-tray/module.

12. A method for battery removal and replacement comprising:
drawing within an apparatus that includes a cell and a battery-tray/module where at least one cell outer surface contacts at least one battery-tray/module mating outer surface a vacuum within the cell that provides at least one relatively inwardly deformed cell outer surface at the location of the at least one battery-tray/module mating outer surface; and
moving the cell with respect to the battery-tray/module in the presence of the at least one relatively inwardly deformed cell outer surface.

13. The method of claim 12 wherein the moving the cell comprises removing the cell.

14. The method of claim 12 wherein the moving the cell comprises replacing the cell.

15. The method of claim 13 wherein an extent of the relatively inwardly deforming of the at least one cell outer surface at the point of contact of the at least one cell outer surface and the at least one battery-tray/module mating outer surface determines an ease of removing the cell from the battery-tray/module.

16. The method of claim 14 wherein an extent of the relatively inwardly deforming of the at least one cell outer surface at the point of contact of the at least one cell outer surface and the at least one battery-tray/module mating outer surface determines an ease of replacing the cell within the battery-tray/module.
